(19) United States
(12) Patent Application Publication
(10) Pub. No.: US 2026/0187914 A1
(43) Pub. Date: Jul. 2, 2026

(54) SYSTEM FOR GENERATING EXPANDED VIEWS OF SELECTED OBJECTS

(71) Applicant: eBay Inc., San Jose, CA (US)

(72) Inventors: Prerna Dubey, Sunnyvale, CA (US); Stephen Laszlo, San Francisco, CA (US)

(21) Appl. No.: 19/003,944

(22) Filed: Dec. 27, 2024

(51) Int. Cl. G06T 17/00

(52) U.S. Cl. CPC G06T 17/00

(57) ABSTRACT

An object request is received and an object of the object request is matched with sub-objects that are displayed in a first view. A selection of a first sub-object of the sub-objects is received and a three-dimensional rendering of the selected first sub-object is generated in response to receiving the selection. The three-dimensional rendering has second sub-objects associated with the first sub-object where each of the second sub-objects are selectable. The three-dimensional rendering is a second view that is an expansion of the first view where the second sub-objects are shown in the second view.

### TECHNICAL FIELD

Examples of the present disclosure relate generally to providing data in response to queries and, more particularly, but not by way of limitation, to providing data in response to a query in a manner that facilitates interaction with the provided data to provide a proper response to the query.

### BACKGROUND

A technical problem that can arise with computing devices is the ability to access and provide data when responding to a query. This can include providing data that is easily decipherable. For example, a user may be searching for a braking assembly part, such as a brake piston. However, the user may not know that the correct name for the braking assembly part is “brake piston.” Thus, when the user conducts a search for brake assembly parts on a computing device, a correct response to a query by the user may not be returned. Furthermore, if images of a braking assembly are provided as a response to the query, a computing device may not provide the data in manner that facilitates a proper response to the brake assembly part query. More specifically, an image of a braking assembly may not show the brake piston since the brake piston can reside behind a brake pad of the braking assembly. Thus, a computing device lacks the ability to access and provide data when responding to a query.

### SUMMARY

Examples relate to a system and method that improves the functioning of a computing device. In particular, the system can receive a query and then facilitate providing a correct response to the query. When the system receives a query, such as an object request, the system can match the object request to a plurality of sub-objects. When the system matches the object request to the plurality of sub-objects, the system can display the plurality of sub-objects in a first view.

A user can manipulate the first view, such as rotating the first view and zooming in and out of the view, to select different ones of the plurality of sub-objects. A user can select a first sub-object of the plurality of sub-objects from the first view. The selection is made when the user manipulates the first view or by making a selection at the first view without manipulating the first view.

When a selection is received, a three-dimensional rendering of the first sub-object is generated. In addition to the first object, the three-dimensional rendering can also include second sub-objects that are associated with the first sub-object. The three-dimensional rendering is a second view that is an expansion of the first view where the second sub-objects are shown in the second view.

When one of the second sub-objects is selected, category tiles are generated that correspond to items associated with the second sub-objects. The category tiles are selectable such that a user can select an item associated with a category tile.

### BRIEF DESCRIPTION OF THE DRAWINGS

Various ones of the appended drawings merely illustrate examples of the present disclosure and should not be considered as limiting its scope.

FIG. 1 is a network diagram illustrating a network environment suitable for receiving object queries and providing response to the object queries, according to some examples.

FIG. 2 illustrates a method for receiving object queries and providing response to the object queries using components of FIG. 1, according to some examples.

FIG. 3 shows results that are found in response to the object queries received while implementing the method of FIG. 3, according to some examples.

FIG. 4 illustrates a first view displayed in response to the object queries received while implementing the method of FIG. 3, according to some examples.

FIG. 5 shows a second view which is expanded from the first view of FIG. 4, according to some examples.

FIG. 6 illustrates category tiles that are generated in response to selections made at the second view of FIG. 5, according to some examples.

FIG. 7 shows an alternate first view using components of FIG. 1, according to some examples.

FIG. 8 illustrates category tiles that are generated in response to selections made at the first view of FIG. 7, according to some examples.

FIG. 9 is a block diagram illustrating architecture of software used to implement social network-initiated listings, according to some examples.

FIG. 10 is a block diagram illustrating a machine as an example computer system with instructions to cause the machine to implement social network-initiated listings, according to some examples.

FIG. 11 is a block diagram illustrating a machine learning pipeline, according to some examples.

FIG. 12 is a data flow diagram illustrating training and use of a machine learning program, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Examples relate to a system and method that improves the functioning of a computing device. In particular, the system can receive a query and then facilitate providing a correct response to the query. When the system receives a query, such as an object request, the system can match the object request to a plurality of sub-objects. When the system matches the object request to the plurality of sub-objects, the system can display the plurality of sub-objects in a first view.

A user can manipulate the first view, such as rotating the first view and zooming in and out of the view, to select different ones of the plurality of sub-objects. A user can select a first sub-object of the plurality of sub-objects from the first view. The selection is made when the user manipulates the first view or by making a selection at the first view without manipulating the first view.

When a selection is received, a three-dimensional rendering of the first sub-object is generated. In addition to the first object, the three-dimensional rendering can also include second sub-objects that are associated with the first sub-object. The three-dimensional rendering is a second view that is an expansion of the first view where the second sub-objects are shown in the second view.

When one of the second sub-objects is selected, category tiles are generated that correspond to items associated with the second sub-objects. The category tiles are selectable such that a user can select an item associated with a category tile.

As an example of an embodiment and referred to herein as “the brake assembly example,” a user may be searching for a brake piston of a brake assembly. However, the user may not know that the name of the item is “brake piston.” Therefore, the user enters the search term “brake assembly,” which is the object request described above.

Upon receipt of the object request “brake assembly,” the system can match the object request with an automobile. In addition, the system can match the object request with a plurality of parts to the automobile. The parts are a brake assembly, a suspension assembly, and a headlight assembly associated with the automobile. The brake assembly, the suspension assembly, and the headlight assembly are sub-objects associated with the automobile. The automobile is displayed in a first view. The first view is manipulated and can display hot spots such that the user can rotate and expand the first view via the hot spots.

The user can select one of the sub-objects, which in the brake assembly example can be the brake assembly. When the user selects the brake assembly, a second view which is a three-dimensional rendering of the brake assembly is generated. The three-dimensional rendering is an expansion of the automobile such that the three-dimensional rendering is an expansion of the first view.

The items shown in the three-dimensional rendering can include brake calipers, brake pads, brake rotors, and brake pistons. Since the user is searching for a brake piston, the user can select the brake piston in the three-dimensional rendering by clicking on the brake piston. After selecting the brake piston, category tiles are displayed to the user in a third view. The category tiles are associated with various brake pistons that the user can select.

Examples solve technical problems associated with computing devices. As noted above, a technical problem that can arise with computing devices is the ability to access and provide data when responding to a query. In particular, a computing device can be ill-equipped to determine how the query should be evaluated and how the evaluated query should be applied to a database to provide a correct response.

Examples solve the technical problem of a computing device being ill-equipped to determine how a query should be evaluated by providing a system for a computing device that receives a query and then facilitates providing a correct response to the query. The system can parse the query and match the parsed query to first sub-objects. The system generates a first view that shows the first sub-objects. The system configures the first sub-objects such that the first sub-objects are selectable. When a first sub-object is selected, the first sub-object is expanded into a second view that includes second sub-objects. The system configures the second sub-objects such that the second sub-objects are selectable. When a second sub-object is selected, category tiles are presented. The system configures the category tiles such that the category tiles are selectable.

By virtue of configuring a computing device to parse a query and generate a first view having first selectable elements based on the parsed query along with configuring the computing device to generate a second view having second selectable elements based on the first selectable elements, this solves the technical problem of a computing device being unable to determine how a query should be evaluated. In particular, the computing device is configured to evaluate a query by determining second sub-objects associated with the query and then display the second sub-objects as selectable elements. Moreover, the computing device is configured to display selectable category tiles.

Furthermore, traditional computing systems face significant technical challenges in effectively processing and presenting complex hierarchical data structures in response to ambiguous queries. These struggles in efficiently mapping unstructured search queries to structured data hierarchies, dynamically generating and rendering interactive 3D visualizations of nested object relationships, and managing computational resources when processing real-time user interactions with complex 3D renderings.

Examples address these problems by providing a system that improves how search results are presented in order to facilitate quick retrieval of data associated with the presented search results. In particular, the system can display a first view having selectable first sub-objects, display a second view having selectable second sub-objects, and display a third view having selectable category tiles. By virtue of generating a first view and generating a second view that is an expansion of the first view when an entity engages the first view, examples discussed herein are tied to a computing device.

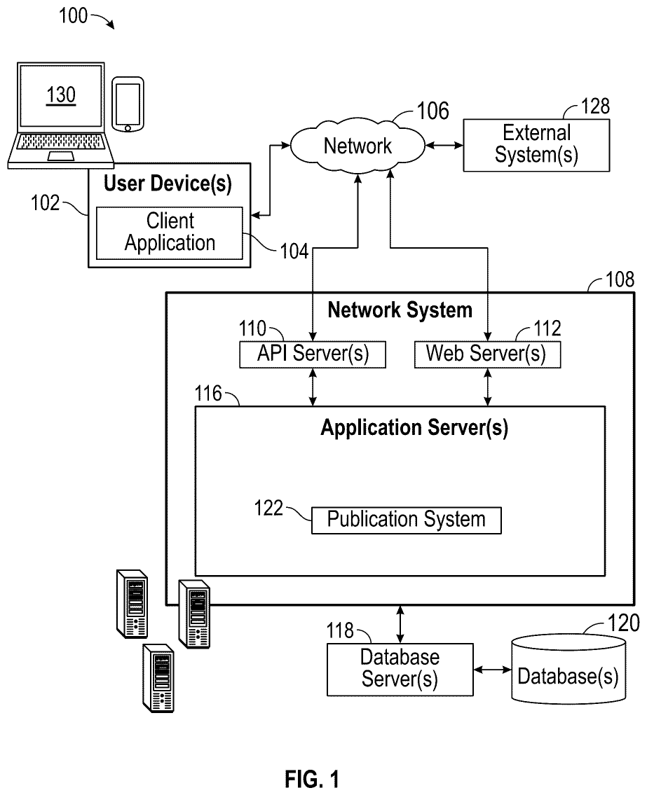

Now turning attention to the Figures and more specifically FIG. 1, FIG. 1 is a block diagram showing an example network environment 100 that includes a publication system 122, according to various examples of the present disclosure. As shown, the network environment 100 includes one or more user devices 102, a network system 108, and a network 106 (e.g., Internet, wide-area-network (WAN), local-area-network (LAN), wireless network) that communicatively couples them together. Each user device 102 can host a number of applications, including a client software application 104. The client software application 104 can communicate and exchange data with the network system 108 via a network 106.

A user device 102 may comprise but is not limited to, a smartphone, tablet, laptop, multi-processor systems, microprocessor-based or programmable consumer electronics, game consoles, or any other communication device that can access the network system 108. Additionally, each user device 102 comprises a display component (not shown) to display information (e.g., in the form of user interfaces) as will be discussed in more detail below.

The network system 108 provides server-side functionality via the network 106 to the client software application 104. While certain functionality is described herein as being performed by the publication system 122, on the server system 108, it will be appreciated that the location of certain functionality within the network system 108 is a design choice. For example, it may be technically preferable to initially deploy certain technology and functionality within the network system 108, but to later migrate this technology and functionality to the client software application 104.

The network system 108 supports various services and operations that are provided to the client software application 104 by a publication system 122. The various services and operations provided by publication system 122 can relate to transmitting data from any one or more of the publication system 122, receiving data from the client software application 104 and processing data generated by the client software application 104. Data exchanges within the network environment 100 may be invoked and controlled through operations of software component environments available via one or more endpoints, or functions available via one or more user interfaces of the client software application 104, which may include web-based user interfaces provided by the server system 108 for presentation at the user device 102.

With respect to the network system 108, one or more application programing interface (API) servers 110 and one or more web servers 112 are coupled to and provide programmatic and web interfaces respectively to one or more application servers 116. The application server(s) 116 host various systems including the publication system 122 which comprises a plurality of components and each of which can be embodied as hardware, software, firmware, or any combination thereof. The application server(s) 116 are, in turn, coupled to one or more database servers 118 that facilitate access to one or more database(s) 120. The database(s) 120 may be stored in one or more storage devices and may, for example, include user accounts including user profiles of users of the network system 108.

The API server(s) 110 receives and transmits data (e.g., API calls, commands, requests, responses, and authentication data) between the user device(s) 102 and the application server 116. Specifically, the API server(s) 110 provides a set of interfaces (e.g., routines and protocols) that can be called or queried by the client software application 104 in order to invoke the functionality of the application server(s) 116. The API server(s) 110 expose various functions supported by the application server 116 including, without limitation, messaging, listing publication, and review of goods and services and sellers thereof.

The publication system 122 manages publications (e.g., articles, listings of available goods or services) and transactions (e.g., for goods and services) at the network system 108 including generating and publishing the publications, conducting searches for publications, and/or maintaining user accounts. In addition, the publication system 122 can function to receive a query and then facilitate providing a correct response to the query.

The environment 100 can also comprise one or more external systems 128. The external system(s) 128 can be a third-party system that performs data operations or processing for the network system 108. For example, the external system(s) 128 can comprise a large language model (LLM) or generative artificial intelligence (AI) system that processes data on behalf of the network system 108. The LLM is a trained model configured to generate text and perform natural language processing tasks such as classifying an intent of messages.

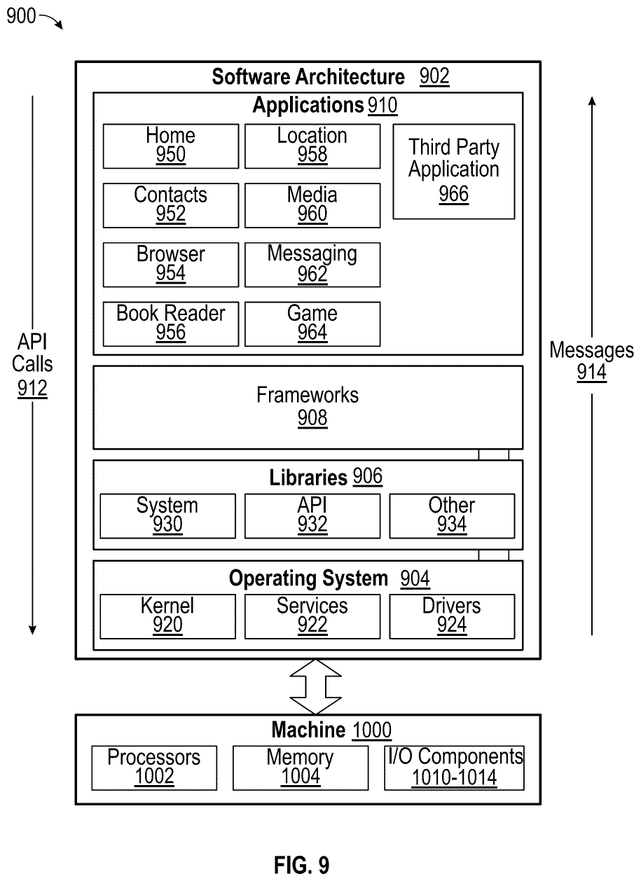

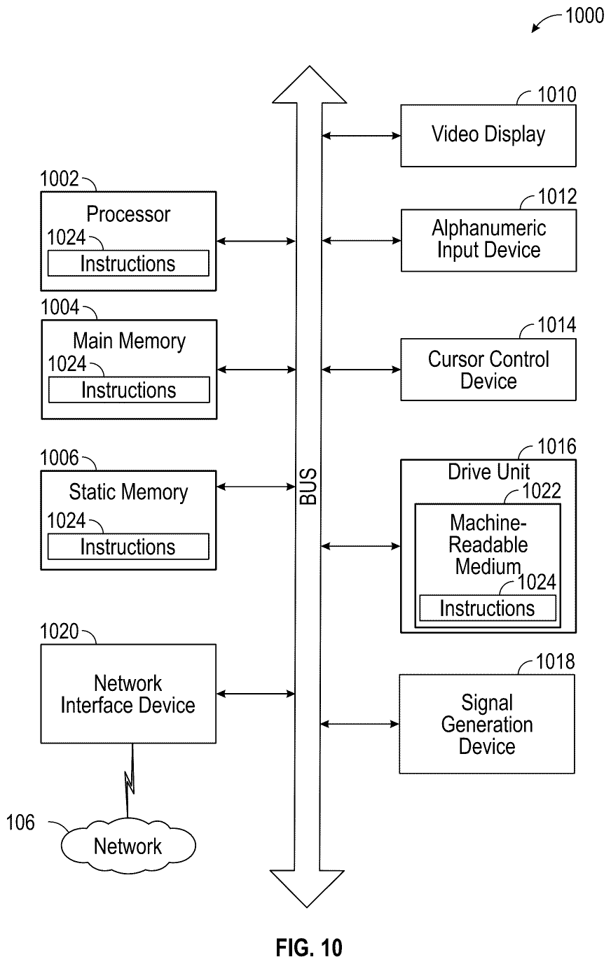

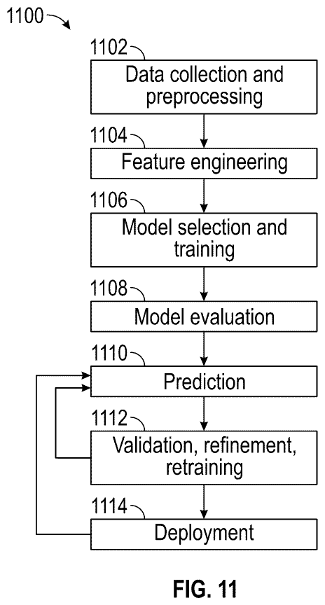

Any of the systems, data storage, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIGS. 9 and 10, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. For example, any of the functionalities discusses above with respect to the publication system 122 may be embodied within the user device 102. While only a single network system 108 is shown, alternatively, more than one network system 108 can be included (e.g., localized to a particular region).

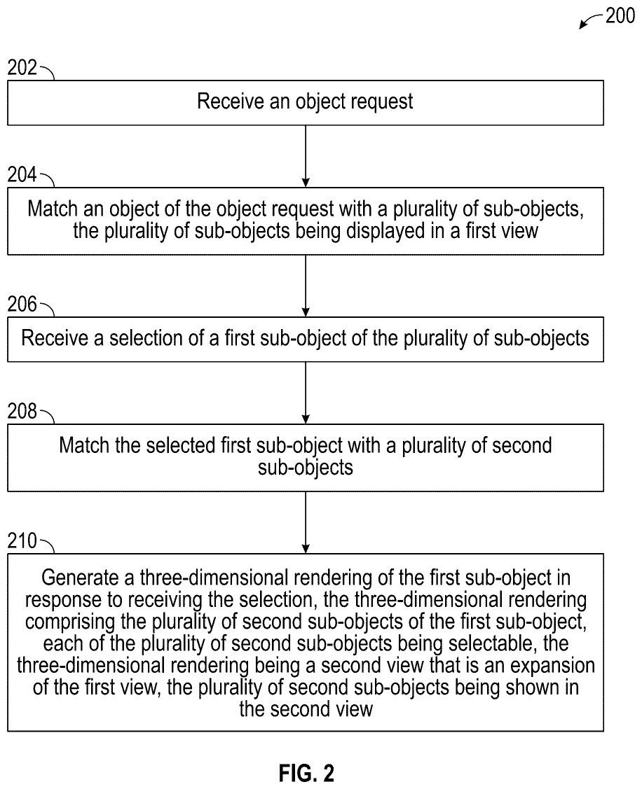

As noted above, examples relate to a system that can receive a query and then facilitate providing a correct response to the query. Now making reference to FIG. 2, a method 200 for receiving a query and providing a response to the query is shown. It will be understood that example methods described herein may be performed by a machine in accordance with some examples. For example, method 200 can be performed by the publication system 122 described with respect to FIG. 1, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 200 may be represented by executable instructions that, when executed by a processor of a computing device, cause the computing device to perform method 200. Accordingly, the operations of the method 200 are described below in reference to such a computing device.

Depending on the embodiment, an operation of an example method described herein may be repeated in different ways or involve intervening operations not shown. Though the operations of example methods may be depicted and described in a certain order, the order in which the operations are performed may vary among examples, including performing certain operations in parallel.

Initially, at an operation 202, an object request is received by the publication system 122. The object request relates to an item that is being searched for by a user. The object request is passed through a query understanding to generate an object search query. A query understanding breaks the object request down into various components, such as keywords, context, and intent. The query understanding can be done using rule-based approaches, statistical methods, or machine learning.

The object search query is parsed by converting the object search query from a first format to a second format, such as transforming the object search query from an unstructured format to a structured format. The converted object search query corresponds to a parsed object search query. For purposes of this discussion, the parsed object search query corresponds to the object. During parsing, the object search query is broken down into smaller components where relevant data is extracted from the smaller components. The smaller components are then organized according to a structure that allows for the utilization of a search engine to provide search results.

The parsed object search query is matched with a plurality of sub-objects at an operation 204 at the publication system 122. The plurality of sub-objects that match the parsed object search query is displayed in a first view. At the operation 204, a search engine of the publication system 122 can match the object, via the parsed object search query, to a dominant category. The dominant category is part of a category tree having a plurality of nodes. The parsed object search query is mapped to the category tree and search results having a highest recall is returned. The highest recall is a ratio of sub-objects returned in relation to a total number of sub-objects. Thus, the search results having the highest ratio, such as the highest number of pertinent received results relative to the total number of nodes in the category tree can be returned. The dominant category includes a plurality of sub-categories, which correspond to the plurality of sub-objects.

In addition to using category trees to match an object to a dominant category to determine a highest recall, visual embeddings can be used. Visual embeddings can include mathematical representations that can convert raw visual data into high-dimensional vectors. The visual embeddings can capture various features and patterns in order to enable tasks such as image recognition, object detection, and visual searching by simplifying and structing data associated with the image. Thus, the data from the visual embeddings can be used to search databases, such as the databases 120, that can store three-dimensional renderings that can correspond to first and second sub-objects described herein.

At the operation 204, the plurality of sub-objects is displayed in a first view at the client device 102. The first view is either a two-dimensional rendering or a three-dimensional rendering. Each of the two-and three-dimensional renderings have portions that are selected by a user. The selectable portions correspond to ones of the plurality of sub-objects. As will be discussed further on, upon selection of a sub-object of the plurality of sub-objects, further renderings corresponding to the selected sub-object are generated.

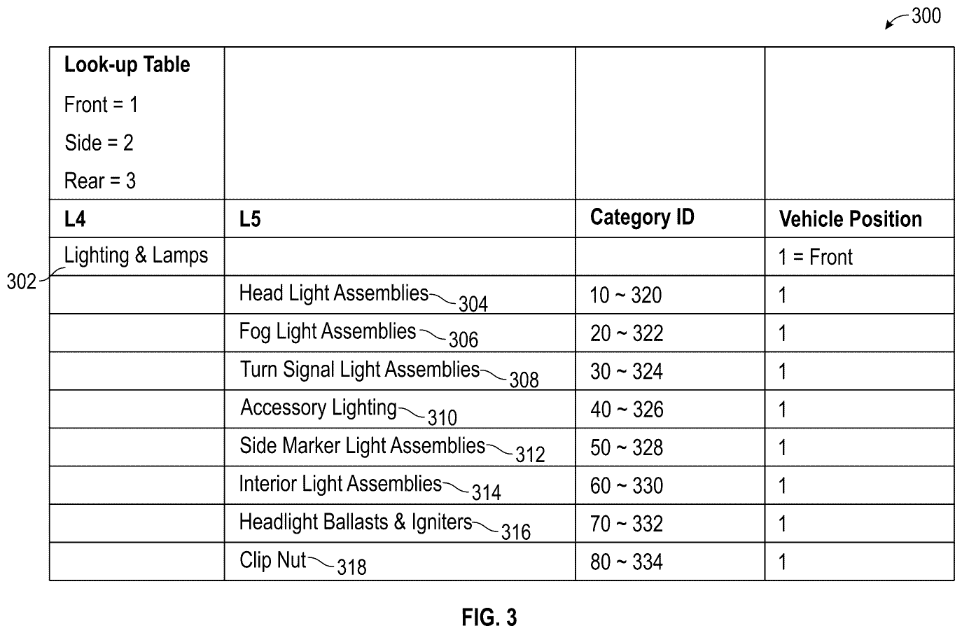

As an example of the method 200 and referred to herein as “the headlight example,” reference is made to FIG. 3. In the headlight example, a user is searching for a fastener that secures a headlight assembly to the body of a vehicle. However, the user does not know that the part they are looking for is called a clip nut. The user only knows that the fastener for which they are searching is part of a headlight assembly. Thus, at the operation 202, the application server 116 can receive the object search query “headlight assembly” via a user interface 130. The application server 116 can cause the user interface 130 to be displayed at the user device 102.

Upon receiving the object search query headlight assembly, the application server 116 can parse the object search query using the techniques described above. The application server 116 can then match headlight assembly to a category tree and retrieve results 300, as shown with reference to FIG. 3. The results can include a dominant category 302 along with first sub-objects 304-318. The first sub-objects 304-318 in the results 300 are curated based on a velocity associated with how often items associated with the first sub-objects 304-318 are consumed. Thus, those items with a velocity that exceeds a threshold, such as those items being consumed, such as being purchased, at a rate that exceeds a threshold, are listed as a sub-object. Alternatively, or additionally, those items that have an access rate that exceeds a threshold, such as those items being accessed at a rate that exceeds a threshold, are listed as a sub-object.

The first sub-objects 304-318 can correspond to sub-categories for a headlight assembly. The first sub-object 304 can correspond to a head light assembly, the first sub-object 306 can correspond to fog light assemblies, the first sub-object 308 can correspond to turn signal light assemblies, and the first sub-object 310 can correspond to accessory lighting. Moreover, the first sub-object 312 can correspond to side marker light assemblies and the first sub-object 314 can correspond to interior light assemblies. In addition, the first sub-object 316 can correspond to headlight ballasts and igniters while the first sub-object 318 can correspond to a clip nut.

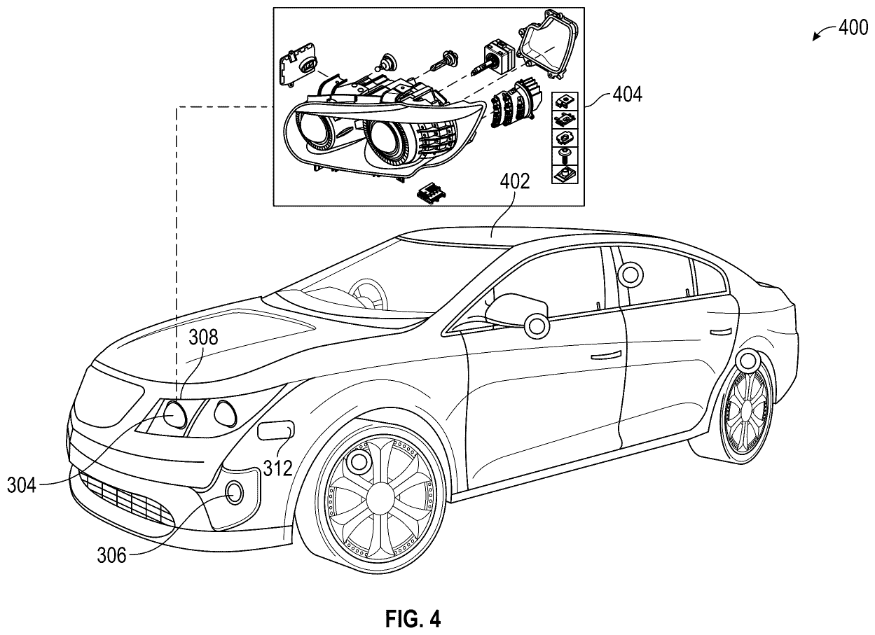

At the operation 204, the plurality of sub-objects is displayed in a first view. In the headlight example, a first view 400, as shown in FIG. 4, is displayed where the application server 116 can render the first view in three-dimensions. The first view 400 can include a vehicle 402. Moreover, the first view 400 can display the ones of the first sub-objects 304-318, such as the first sub-objects 304-308 and 312.

Returning to FIG. 2 and the method 200, at an operation 206, a selection of a first sub-object of the plurality of sub-objects is received by the publication system 122. As noted above, ones of the sub-objects in the first view are selectable. At the operation 206, a user can select one of the sub-objects where the selected sub-object correspond to the item that is being searched for by a user. In further examples, the selected sub-object corresponds to the item for which the user is conducting a search but did not know the proper name. The first sub-object is selected by hovering over the first sub-object with an input element, such as a cursor. Alternatively, the first sub-object is selected by manually clicking the first sub-object with the input element.

In response to receiving the selection, the selected first sub-object is matched with a plurality of second sub-objects, at operation 208 by the publication system 122. As detailed above, an object is passed through a query understanding to generate an object search query. By passing an object through a query understanding, a parsed object search query is generated based on the object search query in order to match the parsed object search query with the plurality of sub-objects. A similar process is performed on the selected first sub-object at the operation 208. Here, the first sub-object is matched to a plurality of second sub-objects as discussed above with reference to the operations 202 and 204.

After the first sub-object is matched to a plurality of second sub-objects, a three-dimensional rendering of the first sub-object is generated at an operation 210 by the publication system 122. The three-dimensional rendering can include the plurality of second sub-objects that were matched to the first sub-objects. The three-dimensional rendering is a second view that is an expansion of the first view. Thus, when the first sub-object is selected, the first view is expanded into the second view.

Each of the sub-objects have an associated category identification (ID), such as category IDs 320-334 shown with reference to FIG. 3. In addition, three-dimensional renderings of each of the sub-objects can be stacked at databases, such as the databases 120. The three-dimensional renderings can also include the category IDs 320-334. Thus, when generating the three-dimensional rendering of a sub-object, such as the first sub-object, the application server 116 can use the category ID of the sub-object to search the databases 120 for the accompanying three-dimensional rendering. The application server 116 can search the databases 120 using a category tree approach where, as mentioned above, the category tree has nodes and sub-nodes associated with each of the nodes. After locating the three-dimensional rendering, the application server 116 can effect generation of the three-dimensional rendering that is associated with a sub-object.

Alternatively, in examples where the first sub-object is selected by hovering over the first sub-object, visual embeddings can be employed to generate the three-dimensional rendering using the techniques described above. In further examples where the first sub-object is selected by hovering over the first sub-object, Cascading Style Sheets (CSS) hover techniques are employed to generate the three-dimensional rendering. The: hover pseudo-class in CSS is used to select the first sub-object when the input element hovers over the first sub-object. The: hover pseudo-class in CSS can allow changes to properties of the first sub-object, such as changing images and providing additional information about the images, wherein the changed images can correspond to the plurality of second images. Moreover, the additional information can correspond to a title associated with each of the plurality of second sub-objects, identifier information for each of the plurality of second sub-objects, a price associated with each of the plurality of second sub-objects, and/or any other type of information.

Furthermore, each of the plurality of second sub-objects is selectable. In particular, each of the second sub-objects is selectable using the techniques discussed above. When one of the second sub-objects is selected, second sub-object information regarding the selected sub-object is presented. The second sub-object information can relate to an item that corresponds to the second sub-object and can include information relating to how a user can purchase the item that corresponds to the selected second sub-object.

Each of the second sub-objects along with the second sub-object information is selectable using the techniques described above. When one of the second sub-objects or the second sub-object information is selected, category tiles are generated and displayed in a third view. The category tiles can provide category tile information associated with the second sub-object. The category tiles can list sources, such as a selling entity, from which the object is available. The category tile information can include a title of the second sub-object, a price associated with the second sub-object, and a delivery estimate for receiving the second sub-object. The category tile information is stored at the databases and have an associated category ID, such as category IDs 320-334 shown with reference to FIG. 3. The category tile information can be searched using the category IDs. The application server 116 can then generate category tiles using the available items found during the search.

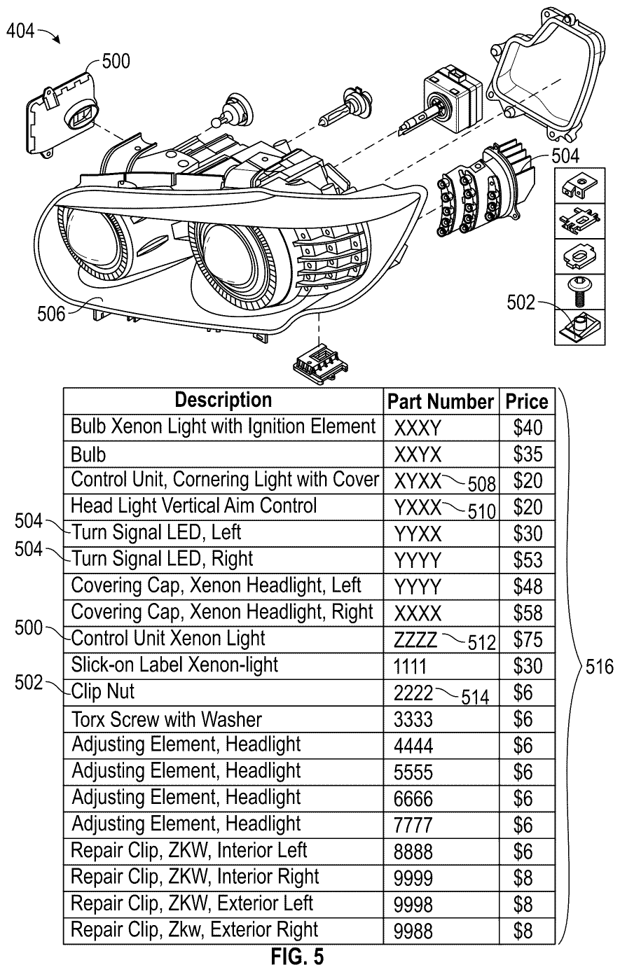

Returning to the headlight example by way of reference to FIGS. 4 and 5, at the operation 206, a user hovers over the first sub-object 304, which can correspond to a headlight assembly. When the user hovers over the first sub-object 304, an expanded view 404 is displayed, as shown with reference to FIG. 5. The expanded view 404 can be overlain the first view 400 as a second view as shown in FIG. 4 and displayed on the user device 102, or a second view can replace the first view 400 and displayed on the user device 102 as a second view as shown in FIG. 5.

The expanded view 404 can include various portions of the first sub-object 304, such as second sub-objects 500-506. In the headlight example, the second sub-object 500 can correspond to a control unit, the second sub-object 502 can correspond to a clip nut, the second sub-object 504 can correspond to a turn signal, and the second sub-object 506 can correspond to a headlight assembly casing. Each of the second sub-objects, such as the sub-objects 500-504, can have associated part numbers 508-514 and associated prices 516. Each of the second sub-objects 500-506, the part numbers 508-514, or the prices 516 are selectable. Upon selection of any of the second sub-objects 500-506, the part numbers 508-514, or the prices 516, a user is directed to the item associated with the selection. The expanded view 404 is provided in response to receiving the object search query. The expanded view 404 can improve how search results are presented in order to facilitate quick retrieval of data associated with presented search results, thereby improving the functioning of a computing device.

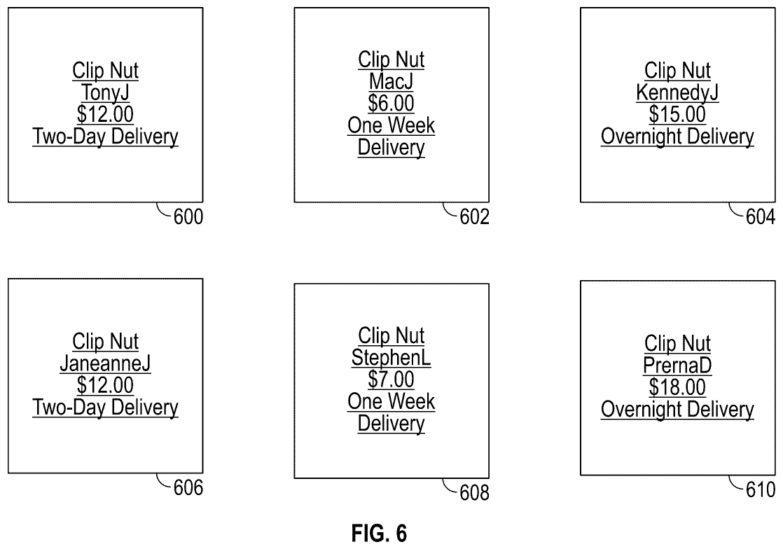

In the headlight example, the user is searching for a clip nut. Therefore, the user can select one of the second sub-object 502, the part number 514, or the price 516 associated with the second sub-object 502 where the each of these are visual renderings. In the headlight example, the user selects the part number 514 such that the user selects one of the visual renderings. In response, category tiles 600-610 as shown in FIG. 6 are generated by the application server 116 and presented and displayed to the user as a third view on the user device 102.

Each of the category tiles 600-610 are selectable and can include information relating to a clip nut. In particular, each of the category tiles 600-610 can include an item name, a source of the clip nut, a price, and delivery information. Thus, the category tiles 600-610 can include information about an item that is being searched for by a user.

The user can select one of the category tiles 600-610 and proceed with obtaining a clip nut. Therefore, in response to selecting one of the category tiles 600-610, the application server 116 can effect the ordering of clip nut, where the application server 116 can effect the communication with the seller of the selected clip nut to begin the process of providing the selected clip nut to the user in the headlight example.

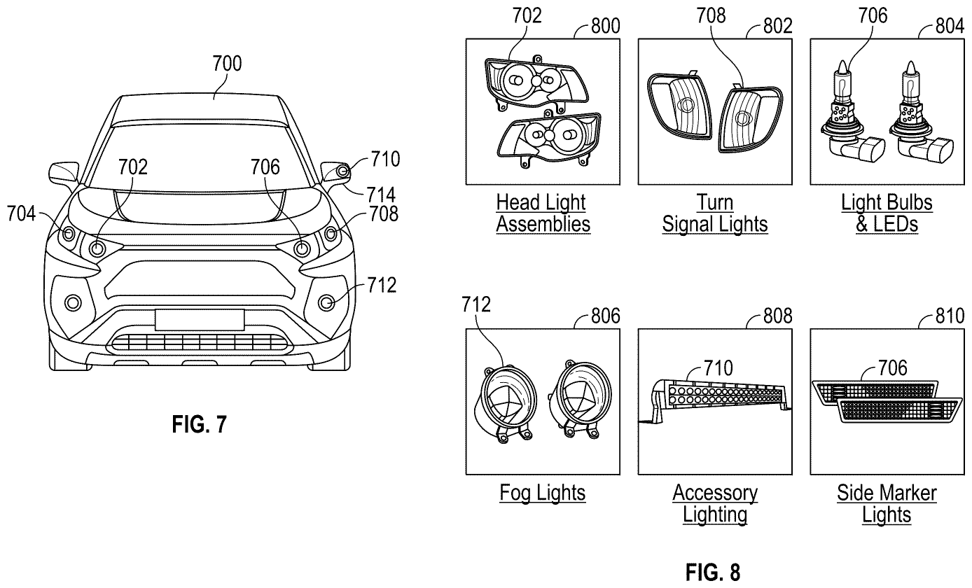

As noted above, the plurality of sub-objects can be displayed in a first view. In examples, the application server 116 can render the first view in two-dimensions in response to receiving the object search query. When the first view is rendered in two-dimensions, a first view 700 can include hotspots 702-712, as shown with reference to FIG. 7.

The hotpots 702-712 can correspond to a plurality of hotspot first sub-objects. The hotspots 702-712 are a specific area on the first view 700, as shown in FIG. 7. The hotspots 702-712 can be an indicator, such as highlighting, on the first view 700. The hotspot first sub-objects are similar to the first sub-objects 304-318 detailed above. Thus, the hot spots 702-712 are generated based on the object search query as detailed above. When one of the hot spots 702-712 is selected, a three-dimensional rendering of a hot spot first sub-object associated with the selected hot spots 702-712 similar to the expanded view 404 is generated and displayed, as discussed above with reference to FIGS. 4 and 5.

The hot spots 702-712 can correspond to category tiles 800-810, which are shown with reference to FIG. 8. When the first view 700 is displayed, the category tiles 800-810 can also be displayed. The category tiles 800-810 can include a visual representation of the hot spots 702-712. Thus, if the user is interested in an item associated with one of the hot spots 702-712, the user can select the category tile of the category tiles 800-810 that corresponds to the hot spot of the hot spots 702-712 having the item that is of interest to the user. When one of the category tiles 800-810 is selected, an expanded view, such as the expanded view 404, is displayed, thereby permitting the user to select an item, as discussed above. To further illustrate, if the user is looking for lights for their rear view mirror 714, the user can select the category tile 808. Upon selection of the category tile 808, category tiles similar to the category tiles 600-610 are displayed, which can allow for the user to select the item.

It should be noted that while the discussion herein references automobiles, this discussion can be applied to anything. More specifically, the object request discussed herein can apply to any type of item, both tangible and intangible, and the discussion herein can relate to the tangible/intangible item. To further illustrate, the first sub-objects and the second sub-objects can be related to and associated with the tangible/intangible item associated with the object request. Furthermore, the first and second views along with the two-dimensional and three-dimensional views can relate to the tangible/intangible item associated with the object request. Furthermore, any discussion herein that relates to a first sub-object is applicable to a second sub-object. Different types of objects that can be the subject of object requests can include machines, industrial equipment, furniture, textiles, clothing, construction equipment, electronics, jewelry, toys, home goods, gardening equipment, sporting goods, or any other type of good. Thus, any discussion relating to the first sub-objects 304-318 is applicable to the second sub-objects 500-506. Likewise, any discussion relating to the second sub-objects 500-506 is applicable to the first sub-objects 304-318.

Sub-objects associated with the category tiles can be listed based on various metrics associated with the category tiles. These metrics can include, but are not limited to, click through rate, module conversion, and/or session engagement. Click through rate can refer to how often one of the category tiles, such as the category tiles 600-610, are clicked. Module conversion can relate to when a user selects one of the category tiles, such as the category tiles 600-610, did the user show an interest in the object, such as spending more time on a listing for an item associated with the selected category tile or purchase the item. Session engagement can relate to whether or not a bid was made for an item associated with the selected category tile, buy an item associated with the selected category tile, or make an offer on an item associated with the selected category tile.

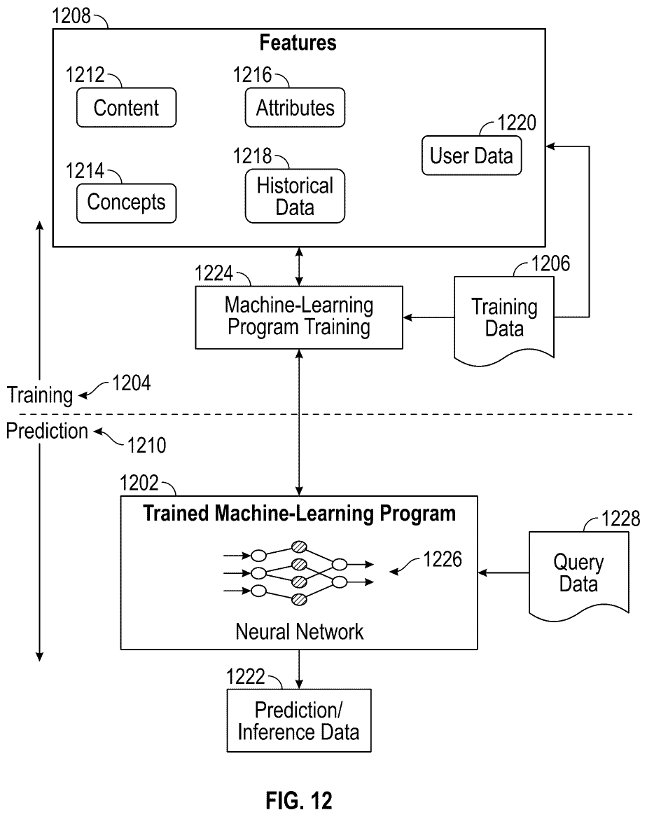

These metrics can be tracked for items associated with the category tiles and then provided as training data to machine learning (ML), as will be discussed further below with reference to FIGS. 11 and 12. An ML model can be trained with the training data at a first time period to determine which items associated with the category tiles should be presented in response to the selection of sub-objects. The output of ML can be monitored over time to determine an output accuracy of ML. The output accuracy can be determined by monitoring the above-referenced metrics and determining when one, all, or a combination of the metrics are above a threshold.

If the metrics changes over time, such as a click through rate decreasing/increasing relative to the threshold, module conversion decreasing/increasing relative to the threshold, and/or session engagement decreasing/increasing relative to the threshold, second training data can be created at a second time based on the metrics changing. The second training data can be provided to ML at the second time period to retrain ML such that the ML, by way of the machine learning model, can change over time.

FIG. 9 is a block diagram 900 illustrating a software architecture 902, which may be installed on any one or more of the devices described above. FIG. 9 is merely a non-limiting example of a software architecture, and it will be appreciated that many other architectures may be implemented to facilitate the functionality described herein. The software architecture 902 may be implemented by hardware such as a computer system 1000 of FIG. 10 that includes a processor 1002, memory 1004 and 1006, and I/O components 1010-1014. In this example, the software architecture 902 may be conceptualized as a stack of layers where each layer may provide a particular functionality. For example, the software architecture 902 includes layers such as an operating system 904, libraries 906, frameworks 908, and applications 910. Operationally, the applications 910 invoke application programming interface (API) calls 912 through the software stack and receive messages 914 in response to the API calls 912, according to some implementations.

In various implementations, the operating system 904 manages hardware resources and provides common services. The operating system 904 includes, for example, a kernel 920, services 922, and drivers 924. The kernel 920 acts as an abstraction layer between the hardware and the other software layers in some implementations. For example, the kernel 920 provides memory management, processor management (e.g., scheduling), component management, networking, and security settings, among other functionality. The services 922 may provide other common services for the other software layers. The drivers 924 may be responsible for controlling or interfacing with the underlying hardware. For instance, the drivers 924 may include display drivers, camera drivers, Bluetooth®drivers, flash memory drivers, serial communication drivers (e.g., Universal Serial Bus (USB) drivers), Wi-Fi®drivers, audio drivers, power management drivers, and so forth.

In some implementations, the libraries 906 provide a low-level common infrastructure that may be utilized by the applications 910. The libraries 906 may include system libraries 930 (e.g., C standard library) that may provide functions such as memory allocation functions, string manipulation functions, mathematic functions, and the like. In addition, the libraries 06 may include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 may also include a wide variety of other libraries 934 to provide many other APIs to the applications 910.

The frameworks 908 provide a high-level common infrastructure that may be utilized by the applications 910, according to some implementations. For example, the frameworks 908 provide various graphic user interface (GUI) functions, high-level resource management, high-level location services, and so forth. The frameworks 908 may provide a broad spectrum of other APIs that may be utilized by the applications 910, some of which may be specific to a particular operating system or platform.

In an example, the applications 910 include a home application 950, a contacts application 952, a browser application 954, a book reader application 956, a location application 958, a media application 960, a messaging application 962, a game application 964, and a broad assortment of other applications such as a third-party application 966. According to some examples, the applications 910 are programs that execute functions defined in the programs. Various programming languages may be employed to create one or more of the applications 910, structured in a variety of manners, such as object-orientated programming languages (e.g., Objective-C, Java, or C++) or procedural programming languages (e.g., C or assembly language). In a specific example, the third-party application 966 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 966 may invoke the API calls 912 provided by the mobile operating system (e.g., the operating system 904) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 106 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 10 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device (cursor control device) 1014 (e.g., a mouse), a disk drive unit 1016, a signal generation device 1018 (e.g., a speaker) and a network interface device 1020.

The drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media. Instructions 1024 may also reside within the static memory 1006.

While the machine-readable medium 1022 is shown in an example to be a single medium, the term “machine-readable medium” may include a single medium or multiple media (e.g., a centralized or distributed database, and/or associated caches and servers) that store the one or more instructions or data instructions 1024. The term “machine-readable medium” shall also be taken to include any tangible medium that is capable of storing, encoding or carrying instructions 1024 for execution by the machine and that cause the machine to perform any one or more of the methodologies of the present invention, or that is capable of storing, encoding or carrying data structures utilized by or associated with such instructions 1024. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 1024 may further be transmitted or received over the network 106 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 1024 for execution by the machine, and includes digital or analog communications signals or other intangible media to facilitate communication of such software.

In various example examples, one or more portions of the network 140 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 106 or a portion of the network 106 may include a wireless or cellular network, and a coupling may be a Code Division Multiple Access (CDMA) connection, a Global System for Mobile communications (GSM) connection, or another type of cellular or wireless coupling. In this example, a coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

FIG. 11 depicts an ML pipeline 1100 and FIG. 12 illustrates training and use of an ML program 1202, in accordance with some examples. While the discussion in FIGS. 11 and 12 focuses on machine learning models, this discussion is equally applicable to multimodal large language learning models where appropriate. The ML 1100 can be used to generate a trained model such as the trained ML program 1202 to perform the operations described herein.

ML may involve using computer algorithms to automatically learn patterns and relationships in data, potentially without the need for explicit programming. ML algorithms can be divided into four main categories: supervised learning, unsupervised learning, self-supervised learning, and reinforcement learning.

For example, supervised learning involves training a model using labeled data to predict an output for new, unseen inputs. Examples of supervised learning algorithms include linear regression, decision trees, and neural networks.

Unsupervised learning involves training a model on unlabeled data to find hidden patterns and relationships in the data. Examples of unsupervised learning algorithms include clustering, principal component analysis, and generative models like autoencoders.

Reinforcement learning involves training a model to make decisions in a dynamic environment by receiving feedback in the form of rewards or penalties. Examples of reinforcement learning algorithms include Q-learning and policy gradient methods.

Examples of specific ML algorithms that may be deployed, according to some examples, include logistic regression, which is a type of supervised learning algorithm used for binary classification tasks. Logistic regression models the probability of a binary response variable based on one or more predictor variables. Another example type of ML algorithm is Naïve Bayes, which is another supervised learning algorithm used for classification tasks. Naïve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data.

Matrix factorization is another type of ML algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of ML algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of ML models is typically evaluated on a separate test set of data that was not used during training to ensure that the model can generalize to new, unseen data. For example, the performance of the ML model discussed above with reference to the category tiles can be evaluated using a separate validation set to ensure it generalizes well to new, unseen messages and message patterns.

Although several specific examples of ML algorithms are discussed herein, the principles discussed herein can be applied to other ML algorithms as well. Deep learning algorithms such as convolutional neural networks, recurrent neural networks, and transformers, as well as more traditional ML algorithms like decision trees, random forests, and gradient boosting may be used in various ML applications.

Two example types of problems in ML are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phase 1204 as described and depicted in connection with FIG. 12 and performed, at least in part, by the multimodal large language learning model 150, in some examples, generating a trained ML program 1202 may include multiple phases that form part of the ML pipeline 1100, including for example the following phases illustrated in FIG. 11: data collection and preprocessing 1102, feature engineering 1104, model selection and training 1106, model evaluation 1108, prediction 1110, validation, refinement, or retraining 1112, and deployment 1114, or a combination thereof.

For example, data collection and preprocessing 1102 can include a phase for acquiring and cleaning data to ensure that it is suitable for use in ML models. This phase may also include removing duplicates, handling missing values, and converting data into a suitable format. Feature engineering 1104 can include a phase for selecting and transforming training data to create features that are useful for predicting the target variable. Feature engineering may include (1) receiving features 1208 (e.g., as structured or labeled data in supervised learning) and/or (2) identifying features 1208 (e.g., unstructured, or unlabeled data for unsupervised learning) in training data. Model selection and training 1106 can include a phase for selecting an appropriate ML algorithm and training it on the preprocessed data. This phase may further involve splitting the data into training and testing sets, using cross-validation to evaluate the model, and tuning hyperparameters to improve performance.

In additional examples, model evaluation 1108 can include a phase for evaluating the performance of a trained model (e.g., the trained ML program 1202) on a separate testing dataset. This phase can help determine if the model is overfitting or underfitting and determine whether the model is suitable for deployment. The prediction 1110 phase includes using a trained model (e.g., trained ML program 1202) to generate predictions on new, unseen data. Validation, refinement, or retraining 1112 can include a phase for updating a model based on feedback generated from the prediction phase, such as new data, or user feedback. Deployment 1114 can include a phase for integrating the trained model (e.g., the trained ML program 1202) into a more extensive system or application, such as a web service, a mobile app, or an IoT device. This phase can involve setting up APIs, building a user interface, and ensuring that the model is scalable and can handle large volumes of data.

FIG. 12 illustrates further details of two example phases, namely a training phase 1204 (e.g., part of the model selection and training 1106), which can an example of the machine learning model used for generating the category tiles, and a prediction 1210 phase (part of the prediction 1110 phase). Prior to the training phase 1204, feature engineering 1104 is used to identify features 1208. This may include identifying informative, discriminating, and independent features for effectively operating the trained ML program 1202 in pattern recognition, classification, and regression. In some examples, the training data 1206 can be features, which can be the metrics that can be tracked for items associated with the category tiles Each of the features 1208 may be a variable or attribute, such as an individual measurable property of a process, article, system, or phenomenon represented by a data set (e.g., the training data 1206). Features 1208 may also be of different types, such as numeric features, strings, and graphs, and may include one or more of content 1212, concepts 1214, attributes 1216, historical data 1218, and/or user data 1220, merely for example and not limitation.

In the training phase 1204, the ML pipeline 1100 uses the training data 1206 to find correlations among the features 1208 that affect a predicted outcome or prediction/inference data 1222. By way of non-limiting example, the training data 1206 can metrics described above.

With the training data 1206 and the identified features 1208, the trained ML program 1202 is trained during the training phase 1204 during ML program training 1224. The ML program training 1224 appraises values of the features 1208 as they correlate to the training data 1206. The result of the training is the trained ML program 1202.

Further, the training phase 1204 may involve ML, in which the training data 1206 is structured (e.g., labeled during preprocessing operations). The trained ML program 1202 implements a neural network 1226 capable of performing, for example, classification and clustering operations. In other examples, the training phase 1204 may involve deep learning, in which the training data 1206 is unstructured, and the trained ML program 1202 implements a deep neural network 1226 that can perform both feature extraction and classification/clustering operations.

In some examples, a neural network 1226 may be generated during the training phase 1204 and implemented within the trained ML program 1202. The neural network 1226 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1226 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1226 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1204, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In the prediction 1110 phase, the trained ML program 1202 uses the features 1208 for analyzing query data 1228 to generate inferences, outcomes, or predictions, as examples of a prediction/inference data 1222. For example, during prediction 1110 phase, the trained ML program 1202 generates an output. Query data 1228 is provided as an input to the trained ML program 1202, and the trained ML program 1202 generates the prediction/inference data 1222 as output, responsive to receipt of the query data 1228.

In some examples, the trained ML program 1202 may be a generative AI model such as an LLM. Generative AI is a term that may refer to any type of artificial intelligence that can create new content from training data 1206. For example, generative AI can produce text, image contents, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like. For example, Convolutional Neural Networks (CNNs) can be used for image content recognition and computer vision tasks. CNNs may, for example, be designed to extract features from image contents by using filters or kernels that scan the input image content and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as image contents or code. In generative AI examples, the output prediction/inference data 1222 can include predictions, translations, summaries, media content, and the like, or some combination thereof.

Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1024 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to various devices. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” “device-readable medium,” and “machine storage medium,” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Described implementations of the subject matter can include one or more features, alone or in combination, as illustrated below by way of example.

Example 1 is a system comprising: at least one processor; and memory comprising instructions that, when executed by the at least one processor, cause the system to perform operations comprising: receiving an object request; matching an object of the object request with a plurality of sub-objects, the plurality of sub-objects being displayed in a first view; receiving a selection of a first sub-object of the plurality of sub-objects; and generating a three-dimensional rendering of the first sub-object in response to receiving the selection, the three-dimensional rendering comprising a plurality of second sub-objects of the first sub-object, each of the plurality of second sub-objects being selectable, the three-dimensional rendering being a second view that is an expansion of the first view, the plurality of second sub-objects being shown in the second view.

In Example 2, the subject matter of Example 1 includes, wherein the instructions further cause the system to perform operations comprising: generating a two-dimensional rendering of the object in the first view; and providing a plurality of hot spots on the two-dimensional rendering of the object, the plurality of hot spots corresponding to the plurality of sub-objects, the hot spots being indicators at the first view.

In Example 3, the subject matter of Example 2 includes, wherein receiving the selection of the first sub-object corresponds to receiving a selection of a hot spot of the plurality of hot spots and the three-dimensional rendering is generated in response to receiving the selection of the hot spot.

In Example 4, the subject matter of Examples 2-3 includes, wherein each of the plurality of sub-objects comprises a category identification and, when generating the three-dimensional rendering, the instructions further cause the system to perform operations comprising matching the category identification with a database of category identifications where the database of category identifications comprises a plurality of three-dimensional renderings associated with the plurality of hot spots.

In Example 5, the subject matter of Examples 2-4 includes, wherein the instructions further cause the system to perform operations comprising: receiving a selection of a second sub-object of the plurality of second sub-objects; and generating a category tile corresponding to the second sub-object.

In Example 6, the subject matter of Examples 1-5 includes, wherein the plurality of second sub-objects are associated with a plurality of items and the three-dimensional rendering comprises a listing of the plurality of items.

In Example 7, the subject matter of Example 6 includes, wherein the three-dimensional rendering comprises a plurality of visual renderings of a plurality of items and the instructions further cause the system to perform operations comprising receiving a selection of an item of the plurality of items via a selection of a visual rendering the plurality of visual renderings.

In Example 8, the subject matter of Example 7 includes, wherein the instructions further cause the system to perform operations comprising submitting an order for the selected item in response to receiving the selection.

Example 9 is a machine-storage medium having instructions embodied thereon, the instructions executable by a processor of a machine to perform operations comprising: receiving an object request; matching an object of the object request with a plurality of sub-objects, the plurality of sub-objects being displayed in a first view; receiving a selection of a first sub-object of the plurality of sub-objects; and generating a three-dimensional rendering of the first sub-object in response to receiving the selection, the three-dimensional rendering comprising a plurality of second sub-objects of the first sub-object, each of the plurality of second sub-objects being selectable, the three-dimensional rendering being a second view that is an expansion of the first view, the plurality of second sub-objects being shown in the second view.

In Example 10, the subject matter of Example 9 includes, the operations further comprising: generating a two-dimensional rendering of the object in the first view; and providing a plurality of hot spots on the two-dimensional rendering of the object, the plurality of hot spots corresponding to the plurality of sub-objects, the hot spots being indicators at the first view.

In Example 11, the subject matter of Example 10 includes, wherein receiving the selection of the first sub-object corresponds to receiving a selection of a hot spot of the plurality of hot spots and the three-dimensional rendering is generated in response to receiving the selection of the hot spot.

In Example 12, the subject matter of Examples 10-11 includes, wherein each of the plurality of sub-objects comprises a category identification and, when generating the three-dimensional rendering, the operations comprise matching the category identification with a database of category identifications where the database of category identifications comprises a plurality of three-dimensional renderings associated with the plurality of hot spots.

In Example 13, the subject matter of Examples 10-12 includes, the operations further comprising: receiving a selection of a second sub-object of the plurality of second sub-objects; and generating a category tile corresponding to the second sub-object.

In Example 14, the subject matter of Examples 9-13 includes, wherein: the plurality of second sub-objects are associated with a plurality of items and the three-dimensional rendering comprises a listing of the plurality of items; and the three-dimensional rendering comprises a plurality of visual renderings of a plurality of items and the operations further comprise: receiving a selection of an item of the plurality of items via a selection of a visual rendering the plurality of visual renderings; and submitting an order for the selected item in response to receiving the selection.

Example 15 is a method comprising: receiving an object request; matching an object of the object request with a plurality of sub-objects, the plurality of sub-objects being displayed in a first view; receiving a selection of a first sub-object of the plurality of sub-objects; and generating a three-dimensional rendering of the first sub-object in response to receiving the selection, the three-dimensional rendering comprising a plurality of second sub-objects of the first sub-object, each of the plurality of second sub-objects being selectable, the three-dimensional rendering being a second view that is an expansion of the first view, the plurality of second sub-objects being shown in the second view.

In Example 16, the subject matter of Example 15 includes, the method further comprising: generating a two-dimensional rendering of the object in the first view; and providing a plurality of hot spots on the two-dimensional rendering of the object, the plurality of hot spots corresponding to the plurality of sub-objects, the hot spots being indicators at the first view.

In Example 17, the subject matter of Example 16 includes, wherein receiving the selection of the first sub-object corresponds to receiving a selection of a hot spot of the plurality of hot spots and the three-dimensional rendering is generated in response to receiving the selection of the hot spot.

In Example 18, the subject matter of Examples 16-17 includes, wherein each of the plurality of sub-objects comprises a category identification and, when generating the three-dimensional rendering, the method further comprises matching the category identification with a database of category identifications where the database of category identifications comprises a plurality of three-dimensional renderings associated with the plurality of hot spots.

In Example 19, the subject matter of Examples 16-18 includes, the method further comprising: receiving a selection of a second sub-object of the plurality of second sub-objects; and generating a category tile corresponding to the second sub-object.

In Example 20, the subject matter of Examples 15-19 includes, wherein: the plurality of second sub-objects are associated with a plurality of items and the three-dimensional rendering comprises a listing of the plurality of items; and the three-dimensional rendering comprises a plurality of visual renderings of a plurality of items and the method further comprises: receiving a selection of an item of the plurality of items via a selection of a visual rendering the plurality of visual renderings; and submitting an order for the selected item in response to receiving the selection.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A system comprising:
at least one processor; and
memory comprising instructions that, when executed by the at least one processor, cause the system to perform operations comprising:
receiving an object request;
matching an object of the object request with a plurality of sub-objects, the plurality of sub-objects being displayed in a first view;
receiving a selection of a first sub-object of the plurality of sub-objects; and
generating a three-dimensional rendering of the first sub-object in response to receiving the selection, the three-dimensional rendering comprising a plurality of second sub-objects of the first sub-object, each of the plurality of second sub-objects being selectable, the three-dimensional rendering being a second view that is an expansion of the first view, the plurality of second sub-objects being shown in the second view.

2. The system of claim 1, wherein the instructions further cause the system to perform operations comprising:
generating a two-dimensional rendering of the object in the first view; and
providing a plurality of hot spots on the two-dimensional rendering of the object, the plurality of hot spots corresponding to the plurality of sub-objects, the hot spots being indicators at the first view.

3. The system of claim 2, wherein receiving the selection of the first sub-object corresponds to receiving a selection of a hot spot of the plurality of hot spots and the three-dimensional rendering is generated in response to receiving the selection of the hot spot.

4. The system of claim 2, wherein each of the plurality of sub-objects has a category identification and, when generating the three-dimensional rendering, the instructions further cause the system to perform operations comprising matching the category identification with a database of category identifications where the database of category identifications comprises a plurality of three-dimensional renderings associated with the plurality of hot spots.

5. The system of claim 2, wherein the instructions further cause the system to perform operations comprising:
receiving a selection of a second sub-object of the plurality of second sub-objects; and
generating a category tile corresponding to the second sub-object.

6. The system of claim 1, wherein the plurality of second sub-objects is associated with a plurality of items and the three-dimensional rendering comprises a listing of the plurality of items.

7. The system of claim 6, wherein the three-dimensional rendering comprises a plurality of visual renderings of a plurality of items and the instructions further cause the system to perform operations comprising receiving a selection of an item of the plurality of items via a selection of a visual rendering the plurality of visual renderings.

8. The system of claim 7, wherein the instructions further cause the system to perform operations comprising submitting an order for the selected item in response to receiving the selection.

9. A machine-storage medium having instructions embodied thereon, the instructions executable by a processor of a machine to perform operations comprising:
receiving an object request;
matching an object of the object request with a plurality of sub-objects, the plurality of sub-objects being displayed in a first view;
receiving a selection of a first sub-object of the plurality of sub-objects; and
generating a three-dimensional rendering of the first sub-object in response to receiving the selection, the three-dimensional rendering comprising a plurality of second sub-objects of the first sub-object, each of the plurality of second sub-objects being selectable, the three-dimensional rendering being a second view that is an expansion of the first view, the plurality of second sub-objects being shown in the second view.

10. The machine-storage medium of claim 9, the operations further comprising:
generating a two-dimensional rendering of the object in the first view; and
providing a plurality of hot spots on the two-dimensional rendering of the object, the plurality of hot spots corresponding to the plurality of sub-objects, the hot spots being indicators at the first view.

11. The machine-storage medium of claim 10, wherein receiving the selection of the first sub-object corresponds to receiving a selection of a hot spot of the plurality of hot spots and the three-dimensional rendering is generated in response to receiving the selection of the hot spot.

12. The machine-storage medium of claim 10, wherein each of the plurality of sub-objects has a category identification and, when generating the three-dimensional rendering, the operations comprise matching the category identification with a database of category identifications where the database of category identifications comprises a plurality of three-dimensional renderings associated with the plurality of hot spots.

13. The machine-storage medium of claim 10, the operations further comprising:
receiving a selection of a second sub-object of the plurality of second sub-objects; and
generating a category tile corresponding to the second sub-object.

14. The machine-storage medium of claim 9, wherein:
the plurality of second sub-objects is associated with a plurality of items and the three-dimensional rendering comprises a listing of the plurality of items; and
the three-dimensional rendering comprises a plurality of visual renderings of a plurality of items and the operations further comprise:
receiving a selection of an item of the plurality of items via a selection of a visual rendering the plurality of visual renderings; and
submitting an order for the selected item in response to receiving the selection.

15. A method comprising:
receiving an object request;
matching an object of the object request with a plurality of sub-objects, the plurality of sub-objects being displayed in a first view;
receiving a selection of a first sub-object of the plurality of sub-objects; and
generating a three-dimensional rendering of the first sub-object in response to receiving the selection, the three-dimensional rendering comprising a plurality of second sub-objects of the first sub-object, each of the plurality of second sub-objects being selectable, the three-dimensional rendering being a second view that is an expansion of the first view, the plurality of second sub-objects being shown in the second view.

16. The method of claim 15, the method further comprising:
generating a two-dimensional rendering of the object in the first view; and
providing a plurality of hot spots on the two-dimensional rendering of the object, the plurality of hot spots corresponding to the plurality of sub-objects, the hot spots being indicators at the first view.

17. The method of claim 16, wherein receiving the selection of the first sub-object corresponds to receiving a selection of a hot spot of the plurality of hot spots and the three-dimensional rendering is generated in response to receiving the selection of the hot spot.

18. The method of claim 16, wherein each of the plurality of sub-objects has a category identification and, when generating the three-dimensional rendering, the method further comprises matching the category identification with a database of category identifications where the database of category identifications comprises a plurality of three-dimensional renderings associated with the plurality of hot spots.

19. The method of claim 16, the method further comprising:
receiving a selection of a second sub-object of the plurality of second sub-objects; and
generating a category tile corresponding to the second sub-object.

20. The method of claim 15, wherein:
the plurality of second sub-objects is associated with a plurality of items and the three-dimensional rendering comprises a listing of the plurality of items; and
the three-dimensional rendering comprises a plurality of visual renderings of a plurality of items and the method further comprises:
receiving a selection of an item of the plurality of items via a selection of a visual rendering the plurality of visual renderings; and
submitting an order for the selected item in response to receiving the selection.
